(19) United States
(12) Patent Application Publication
(10) Pub. No.: US 2006/0259559 A1
(43) Pub. Date: Nov. 16, 2006

(54) System and method for e-mail storage

(76) Inventors: George Sullivan, Bethesda, MD (US); Demsas Abraha, Bethesda, MD (US)

Correspondence Address: VENABLE LLP, P.O. BOX 34385, WASHINGTON, DC, 20043-9998, US

(21) Appl. No.: 11/357,192

(22) Filed: Feb. 21, 2006

Related U.S. Application Data
(60) Provisional application No. 60/653,954, filed on Feb. 18, 2005.

(51) Int. Cl. G06F 15/16

(52) U.S. Cl. 709/206

(57) ABSTRACT

In an environment such as the Microsoft Exchange server environment, the present invention uses an event notification mechanism to identify and store incoming and outgoing electronic mail in secondary storage. With respect to electronic mail, there is an event notification at the detection of either an internal or external message. This notification is provided with a unique identification of the message, and then the message is sent to secondary storage. The journaling feature that is commonly available in systems such as Microsoft Exchange is not used as a source from which to copy messages for secondary storage. By not using journaling, there is a significant savings of processing resources. After storage in secondary storage, any copy of the email that may be residing in local storage at the exchange group can be deleted according to administration-defined policies. The storage format in secondary storage is that of RFC 2822 in an embodiment of the invention. The email is stripped of its Microsoft Exchange format and then treated as a single file that includes both message and header data. The file is then stored in RFC 2822 format in this embodiment. In an alternative embodiment, the file can be stored in XML format.

### CROSS REFERENCE TO RELATED APPLICATION

The applicants claim the benefit of U.S. Application No. 60/653,954 filed on Feb. 18, 2005.

The present invention relates to a system and method to collect and store electronic mail files in a secondary or archival storage system and more particularly, for the storage of electronic mail messages that are received in an environment such as a Microsoft Exchange server environment.

### BACKGROUND OF THE INVENTION

Most private companies implement policies to delete electronic messages after a predetermined time, usually within a few months of reception or transmission. The reasons for the deletion of these files may include attempts to reduce information technology management costs, to prevent potential litigants from introducing messages as evidence in criminal or civil lawsuits, or to simply avoid the costs and expense with retaining and managing such information. However, in some circumstances companies and government agencies require retention of every message sent through an organization. For example, the Securities and Exchange Commission (SEC) requires retention of all messages relating to a broker-dealer's business. Some states, such as the State of Florida, require its agencies to store all email messages for public record retrieval under the Florida Sunshine Law. Other legislation may impose additional requirements on various companies to retain electronic messages such as the Sarbanes-Oxley Act, SEC Rule 17A-4, Gramm-Leach-Bliley Act (Financial Institution Privacy Protection Act of 2001, Financial Institution Privacy Protection Act of 2003); and the Healthcare Insurance Portability and Accountability Act of 1996 (HIPAA). In addition, in the event that an organization is anticipating a lawsuit or has been the subject of a lawsuit, some courts will impose requirements that relevant documents, including electronic mail, be retained during the course of the litigation. In summary, the electronic messages that are generated and received by a company are generally owned by that company, and the company may want to actively manage how that information is retained, destroyed or used. These messages may have value and the information contained therein and the ability to efficiently retrieve the messages is desirable.

In view of the large volume of electronic messages that are sent or received on a system, the existence of large number of files on a local server can impede processor performance. For example, each time a particular mailbox is opened, all of the electronic files that are associated with that mailbox or address must be accessible. Each mailbox is associated with corresponding storage at a storage group that may be co-located with a mail server. Further, the primary storage group or local server on which the processor stores these messages has a finite capacity and, as that capacity is reached, the files must either be deleted or moved to an alternative storage. The local storage option, or primary storage such as at the desktop of the message recipient of on the exchange server, is necessarily more limited. The search and retrieval of archival messages on the primary server places additional load on system resources.

The storage of files on a primary storage medium is relatively expensive compared to the costs of secondary storage media, such as one or more disks having an advanced technology attachment (ATA) interface or serial ATA (SATA) interface. Further, this local storage option is may not be optimized for the storage and retrieval of a particular file type.

In view of these problems, a number of alternative strategies have been pursued to minimize the number of files residing on the primary storage medium. Some companies delete mail from the primary storage server after a predetermined time, or after a predetermined interval after a file was last accessed. The deletion of mail may also be contingent on other events or in response to active management criteria. While the systematic deletion of files effectively removes electronic files from the primary server, this technique may not be satisfactory for many situations. In addition, in the event that active steps are not employed to retain important or sensitive files, this material may be lost. After the deletion of the files the storage media may be written over with new electronic files.

An alternative to the deletion of the files is to store the e-mails in an archival storage system, also referred to as secondary storage structure. Archival storage is less expensive and allows the server system to function more efficiently. As discussed above, the storage medium used in secondary storage can be ATA or SATA disks but the media may be a can be wide variety of media including disk, tape or electronic files. There have been a number of architectures and strategies developed to migrate electronic files from the primary to archival storage.

The use of secondary storage often takes advantage of journaling that is performed at a mail server. Journaling is common in Microsoft Exchange Server environments. Journaling captures copies of user's messages within the Exchange system. Journaling lets an administrator capture all messages to another recipient (i.e., mailbox, custom recipient, or public folder) as soon as anyone submits or receives the message.

One problem with message journaling is that it requires additional system resources. In particular, it increases system load as much as 30 percent, depending on hardware configuration and the message load. Journaling will increase workload in part because journaling routes all messages through message transfer agents (MTAs). In addition, the internet mail service (IMS) and the information store (IS) service use additional resources to process local messages. If the journal recipient is placed on a remote server, all client-based messages must use network bandwidth to send a copy of that message to the server.

As described above, journaling is a just one step in a possible archival solution. The messages that have been journaled still reside on the primary server. Further, journaling increases demands on the processor as described above. In conventional archiving systems for electronic mail, files are moved from the primary storage to a secondary storage media using journaling. The journaling procedure first creates a data structure and then sends all of the messages to the data structure. Next the contents of the structure are copied to the secondary storage media. A problem and disadvantage with this technique is that the copying step increases the amount of data held at the server. The new copy must then be processed and moved to the secondary storage. In view of the magnitude of the data, these steps require significant processing time.

### BRIEF DESCRIPTION OF THE INVENTION

In an environment such as the Microsoft Exchange server environment, the present invention uses an event notification mechanism to identify and store incoming and outgoing electronic mail in secondary storage. With respect to electronic mail, there is an event notification at the detection of either an internal or external message. This notification is provided with a unique identification of the message, and then the message is sent to secondary storage. The journaling feature that is commonly available in systems such as Microsoft Exchange is not used as a source from which to copy messages for secondary storage. By not using journaling, there is a significant savings of processing resources. After storage in secondary storage, any copy of the e-mail that may be residing in local storage at the exchange group can be deleted according to defined policies.

The storage format in secondary storage is that of RFC 2822 in an embodiment of the invention. The email is first stripped of its Microsoft Exchange format and then treated as a single file that includes both message and header data; the file is then stored in RFC 2822 format in this embodiment. In an alternative embodiment, the file can be stored in XML format.

### BRIEF DESCRIPTION OF THE DRAWINGS

FIG. 1 is a schematic representation of the system architecture, according to an embodiment of the invention.

FIG. 2 is a process flow diagram showing the manner in which the system manages an incoming electronic mail message, according to an embodiment of the invention.

FIG. 3 is a process flow diagram showing the event notification process and the storage of an email message, according to an embodiment of the invention.

### DETAILED DESCRIPTION

Embodiments of the invention are discussed in detail below and described in accompanying figures. In describing embodiments, specific terminology is employed for the sake of clarity. The invention is not intended to be limited to the specific terminology so-selected. While specific exemplary embodiments are discussed, it should be understood that this is done for illustration purposes only. A person skilled in the relevant art will recognize that other components and configurations can be used without departing from the spirit and scope of the invention.

In an environment such as the Microsoft Exchange server environment, the present invention uses an event notification mechanism to identify and store incoming and outgoing electronic mail in secondary storage. With respect to electronic mail, there is an event notification at the detection of either an internal or external message. This notification is provided with a unique identification of the message, and then the message is sent to secondary storage. The journaling feature that is commonly available in systems such as Microsoft Exchange is not used as a source from which to copy messages for secondary storage. By not using journaling, there is a significant savings of processing resources. After storage in secondary storage, any copy of the email that may be residing in local storage at the exchange group can be deleted according to administration-defined policies. The storage format in secondary storage is that of RFC 2822 in an embodiment of the invention. The email is stripped of its Microsoft Exchange format and then treated as a single file that includes both message and header data. The file is then stored in RFC 2822 format in this embodiment. In an alternative embodiment, the file can be stored in XML format.

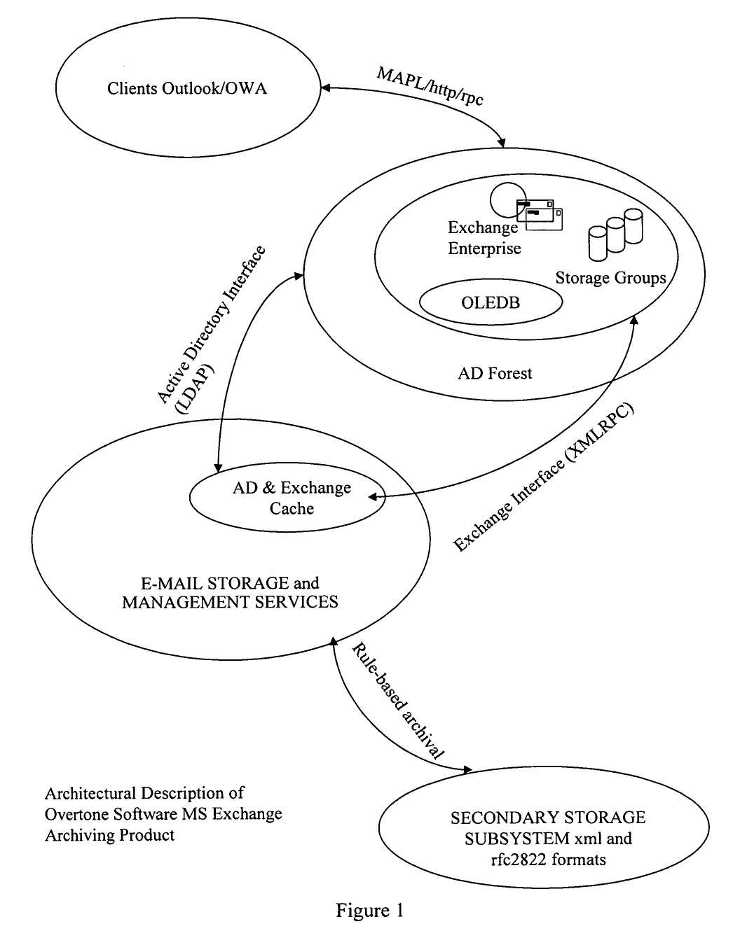

The overall architecture of an embodiment of the invention is shown in FIG. 1. A set of clients, such as Microsoft (MS) Outlook clients, is shown. The clients are connected to an e-mail server, such as an MS Exchange server. This connection can be through a network, for example (not shown). In the illustrated embodiment, the server supports an active directory forest associated with a domain. Email is stored in storage groups that may be implemented as storage area network (SAN) or network attached storage (NAS), for example.

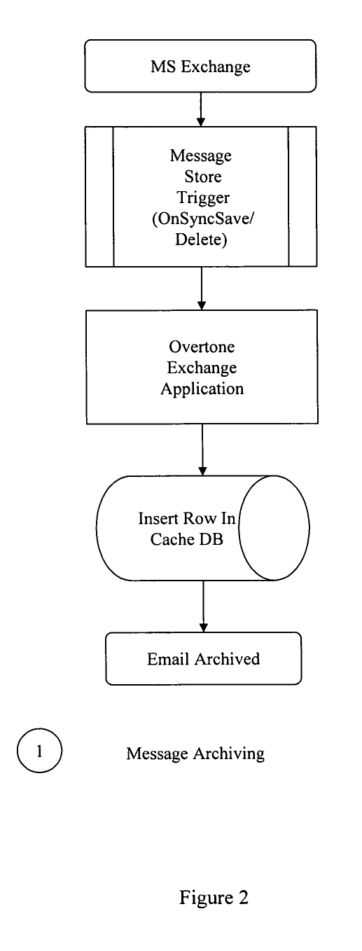

When an e-mail arrives at the server, the MS “onSave” event notification is triggered. Analogously, upon a deletion action, the MS “onDelete” event notification is triggered. In the case of an arriving e-mail, the “onSave” is detected by a process (identified as the Overtone Exchange Application in FIG. 2) that is part of the services logic as disclosed herein. This process obtains the unique identifier (ID) of the message and thereby requests a copy of the message from the storage groups. The e-mail can then be stored in secondary storage. In an embodiment of the invention, any attachments to the e-mail are also stored there. Note that journaling is not used in this process.

In an embodiment of the invention, headers of e-mails are stored in a cache that is maintained by the services disclosed herein. The stored headers can be used for purposes of deleting an e-mail message from the storage groups, for example.

Additional logic that may be provided according to the invention include an interface to the Exchange server and storage groups, where the interface monitors attributes of e-mails stored there and deletes them as dictated by system policies. If the policies require that e-mails older than one day be deleted, for example, an e-mail will be deleted when a day has elapsed since its arrival. Alternative policies may require different deletion requirements for different sender domains, for example. Note that when deletion takes place, a link is left in the storage groups, so that a user will still be able to access a message that is in secondary storage. A user would therefore attempt to access a message that would otherwise be stored in the storage groups, and accesses the link instead. The link would then be used to access the appropriate location in secondary storage where the message has been stored. In an embodiment of the invention, a link to secondary storage may be provided at a user's machine, allowing the user direct access to the link.

Note that in an embodiment of the invention, storage in secondary storage can be done in the RFC 2822 format. The email is first stripped of its MS Exchange format and then treated as a single file that includes both message and header data. The file is then stored in RFC 2822 format in this embodiment. In an alternative embodiment, the file can be stored in XML format after removal of the MS Exchange format.

FIG. 2 illustrates the overall process of the invention. In the context of MS Exchange, a message store operation triggers the event notification onSave; deletion triggers onDelete. A process, shown here and identified in FIG. 2 as the Overtone Exchange Application, responds by caching the header information, obtaining a copy of the incoming email message, and archiving the message in secondary storage.

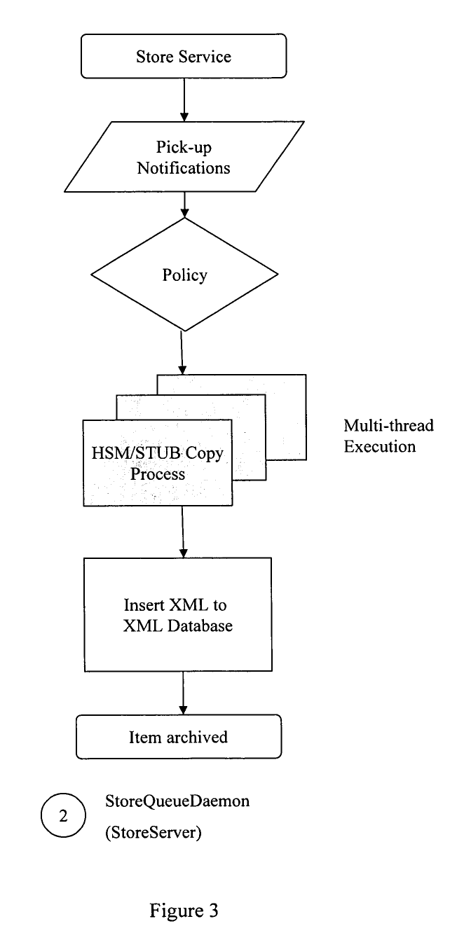

The process of responding to event notifications is shown in greater detail in FIG. 3. Once an event notification is detected (“picked up”) the e-mail message is copied to secondary storage in, for example, XML format. The process of deleting a message from the storage groups (and leaving behind a link or stub) is controlled by one or more policies, as described above.

We claim:

1. A system for managing and storing e-mail communications comprising an e-mail server for transmittal and reception of e-mail communications, a plurality of client stations each in communication with said server and each having a local storage medium, and a secondary archival storage medium, said secondary archival storage medium also in communication with said e-mail server, and software operating said e-mail server to a create a copy of e-mail communications transmitted from said server prior to transmission of said e-mail from said e-mail server, and to transmit said copy to said secondary archival storage medium.

2. The system recited in claim 1 wherein said server is operating in a Microsoft Exchange environment.

3. The system recited in claim 2 wherein incoming or outgoing e-mail passing though the e-mail server is copied in response an event notification action that is initiated upon the detection of an incoming or outgoing e-mail.

4. The system recited in claim 3 wherein a unique identification code is associated with the event notification.

5. The system recited in claim 2 wherein said e-mail communications is stored in a native application.

6. The system recited in claim 4wherein said e-mail communication is stored in XML format.

7. The system recited in claim 4 wherein said e-mail communication is stored in RFC 2822 format.

8. The system according to claim 1 wherein the access to said secondary archival storage medium is limited to predetermined administrators.

9. The system recited in claim 1 wherein said secondary archival storage medium is selected from a group consisting of ATA disks, SATA disks, tape or electronic files.

10. The system according to claim 1 wherein said e-mail that is routed or created and stored in said local storage medium is actively managed.

11. The system recited in claim 1 wherein any attachments to said e-mail transmission or reception are also copied and routed to said secondary storage medium.

12. A method for archiving e-mail communications comprising receiving e-mail communications at a central server, said central server functioning as a central domain for a plurality of clients in an internal private network assigned to said domain, creating an event notice when e-mail is received at a server from an external communication or generated from a client, copying said communication in response to said event notice, transmitting said copy of a communication to a secondary storage medium in said internal private network.

13. The method recited in claim 12 wherein said e-mail communication is converted to XML format for storage in said secondary storage medium.

14. The method recited in claim 12 wherein said e-mail communication is converted to RFC 2822 format for storage in said secondary storage medium.

15. The method recited in claim 12 wherein said secondary storage medium is located in a storage area network.

16. The method recited in claim 12 wherein said secondary storage medium is located in network attached storage.
